(19) United States
(12) Patent Application Publication
(10) Pub. No.: US 2006/0274252 A1
(43) Pub. Date: Dec. 7, 2006

(54) Driver IC package with improved heat dissipation

(75) Inventor: Sun-Kyu Son, Yongin-si (KR)

Correspondence Address: DLA PIPER RUDNICK GRAY CARY US, LLP, 2000 UNIVERSITY AVENUE, E. PALO ALTO, CA, 94303-2248, US

(73) Assignee: Samsung Electronics Co., Ltd.

(21) Appl. No.: 11/445,719

(22) Filed: Jun. 2, 2006

(30) Foreign Application Priority Data
Jun. 3, 2005 (KR) 10-2005-0047689

(51) Int. Cl. G02F 1/1345

(52) U.S. Cl. 349/149

(57) ABSTRACT

A driver IC package capable of being used in a display device and a display device incorporating the driver IC package are presented. The driver IC package includes a base film, a signal pattern formed on a first side of the base film, an IC chip mounted on the base film and connected to the signal pattern, and a heat radiation pattern formed on a second side of the base film. The base film is located between the IC chip and the heat radiation pattern. The heat radiation pattern, which may be made of a thermally conductive material, helps dissipate the heat generated by the IC chip.

### CROSS-REFERENCE TO RELATED APPLICATIONS

The present application claims priority to Korean patent application No. 2005-0047689 filed in the Korean Intellectual Property Office on Jun. 3, 2005, and all the benefits accruing therefrom under 35 U.S.C.§119, the contents of which are herein incorporated by reference in their entirety.

### BACKGROUND OF THE INVENTION

(a) Field of the Invention

The present invention relates to a driver IC package and a display device provided with the driver IC package, and more particularly to a driver IC package with improved heat dissipation and a display provided with the improved driver IC package.

(b) Description of the Related Art

Recently, there has been a dramatic increase in demand for a compact, light-weight display such as an LCD (Liquid Crystal Display).

With advantages of compactness, light weight, and low power consumption, LCD has become a welcome substitute for the conventional CRT (Cathode Ray Tube). Today, LCD has established its place as one of the most commonly used display devices.

Generally, a display device includes a panel unit for displaying images and a PCB (Printed Circuit Board) for supplying driving signals to the panel unit, among other components. This PCB is electrically connected to the panel unit through a driver IC package. Such driver IC package is formed by mounting an IC chip on a base film.

The degree of integration with the IC chips has recently increased, causing a higher voltage to be applied to the IC chips and increasing heat radiation from the IC chips. If a driver IC package does not dissipate the heat generated from the IC chip, the elements in the IC chip deteriorate from overheating and the performance of the IC chip becomes compromised. Thus, it is desirable to provide a means for effective heat dissipation for the IC chips.

### SUMMARY OF THE INVENTION

The present invention provides a driver IC package with improved heat dissipation. In addition, the present invention provides a display device with the driver IC package.

In one aspect, the invention is a driver IC package that includes a base film, signal patterns formed on a first side of the base film, an IC chip mounted on the base film, and a heat radiation pattern formed on a second side of the base film. The IC chip is mounted on the base film via a bonding structure and connected to the signal patterns. The heat radiation pattern is positioned such that the base film is between the IC chip and the heat radiation pattern.

A plurality of heat escape holes may be formed through the base film between the IC chip and the heat radiation pattern.

In another aspect, the driver IC package may further include heat transferring portions physically coupled to the heat radiation pattern. The heat transferring portions may extend through the heat escape holes.

The heat transferring portions may be made of the same material as that of the heat radiation pattern.

The signal pattern and the heat radiation pattern may be formed by depositing metallic materials on the base film using a sputtering method.

The signal pattern and the heat radiation pattern may be made of the same metallic material.

The metallic material may be copper.

The heat radiation pattern may include a lattice formation.

The thickness of the heat radiation pattern may be equal to or less than the thickness of the signal pattern.

The thickness of the heat radiation pattern may be in the range of about 5 μm to about 20 μm.

In another aspect, the invention is a display device that includes a panel unit for displaying images, a PCB for transmitting driving signals to the panel unit, and a driver IC package for electrically connecting the PCB to the panel unit. The driver IC package includes a base film, a signal pattern formed on a first side of the base film, an IC chip mounted on the base film via a bonding structure and connected to the signal pattern, and a heat radiation pattern formed on the second side of the base film. The heat radiation pattern is formed such that the base film is between the IC chip and the heat radiation pattern.

A plurality of heat escape holes may be formed through the base film between the IC chip and the heat radiation pattern.

In another aspect, the display device may further include heat transferring portions physically coupled to the heat radiation pattern. The heat transferring portions may extend through the heat escape holes.

The heat transferring portions may be made of the same material as that of the heat radiation pattern.

The signal pattern and the heat radiation pattern may be formed by depositing a metallic material on the base film using a sputtering method.

The signal pattern and the heat radiation pattern may be made of the same metallic material.

The metallic material may be copper.

The heat radiation pattern may include a lattice formation.

The thickness of the heat radiation pattern may be equal to or less than the thickness of the signal pattern.

The thickness of the heat radiation pattern may be in the range of about 5 μm to about 20 μm.

In another aspect, the display device may further include a backlight assembly for providing light to the second side of the panel unit.

The panel unit may be a liquid crystal panel unit.

### BRIEF DESCRIPTION OF THE DRAWINGS

The above and other features and advantages of the present invention will become more apparent by describing in detail exemplary embodiments thereof with reference to the attached drawings, in which:

FIG. 1 is an exploded perspective view of a display device provided with a driver IC package according to the first embodiment of the present invention;

FIG. 2 is cross-sectional view of the driver IC package taken along the line II-II of FIG. 1;

FIG. 3 is a rear view of the driver IC package of FIG. 2;

FIG. 4 is a block diagram illustrating a panel unit of the display device shown in FIG. 3 and a structure for driving the panel unit;

FIG. 5 is a circuit diagram of a pixel in the display device of FIG. 3;

FIG. 6 is a partial cross-sectional view of the driver IC package according to the second embodiment of the present invention; and

FIG. 7 is a partial cross-sectional view of the driver IC package according to the third embodiment of the present invention.

### DETAILED DESCRIPTION OF THE EMBODIMENTS

Hereinafter, a driver IC package according to embodiments of the present invention and a display device provided with the driver IC package will be described in detail with reference to the attached drawings. However, the embodiments are only for illustrating the present invention, and the present invention is not limited thereto.

For clarity of illustration, portions not related to the illustration will be omitted and the same reference numbers will refer to the same or similar elements throughout the specification.

Elements having the same structure will be representatively explained in the first embodiment, and descriptions of the subsequent embodiments will focus on elements that are different from the first embodiment.

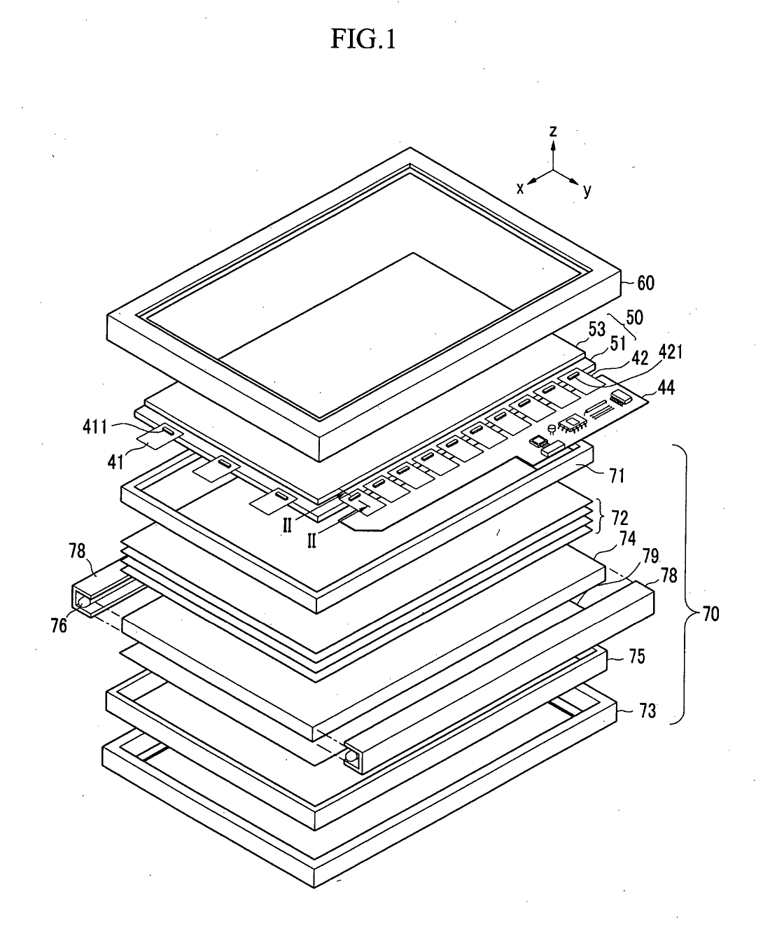

FIG. 1 illustrates a display device 100 that is provided with driver IC packages 41 and 42 according to the present invention. Here, a driver IC package includes a gate driver IC package 41 and a data driver IC package 42. Although a display device 100 provided with an edge-type backlight assembly 70 is shown in FIG. 1, this is an exemplary embodiment to illustrate the present invention, and the present invention is not limited to combination with an edge.

In addition, although a display device provided with a liquid crystal panel unit is shown in FIG. 1, this is an exemplary embodiment to illustrate the present invention and the present invention is not limited thereto. The present invention is applicable to display devices of different other than the LCD as long as the driver IC packages 41 and 42 are used.

As shown in FIG. 1, a display device 100 according to a first embodiment of the present invention includes a backlight assembly 70 for supplying light and a panel unit 50 for displaying images after receiving the light. In addition, the display device 100 further includes a front supporting member 60 for fixing and supporting the panel unit 50 on the backlight assembly 70, and may include other portions if necessary. As used herein, the “front” of the display device 100 refers to the top of FIG. 1, and the “rear” of the display device refers to the bottom of FIG. 1.

In addition, the display device 100 further includes a PCB 44 and driver IC packages 41 and 42 shown in FIG. 1. The PCB 44 is electrically connected to the panel unit 50 and transmits driving signals thereto.

The backlight assembly 70 includes a light source unit 76 for providing light, a light guiding plate 74, a reflecting sheet 79 disposed on the lower side of the light guiding plate 74 so as to reflect the light emitted from the light source unit 76, a light source cover 78 which surrounds the light source unit 76, and optical sheets 72 for providing light emitted from the light source unit 76 to the panel unit 50. The light guiding plate 74 and the optical sheets 72 guide the light emitted from the light source unit 76 to the panel unit 50. The reflecting sheet 79 reflects the light emitted from the light source 76. The inner surface of the light source cover 78 is coated with a reflecting material so as to reflect the light emitted from the light source unit 76. Further, the backlight assembly 70 includes an upper supporting frame 71, a rear supporting member 75, and a lower supporting frame 73, for receiving and supporting the above elements. There may be additional elements of the backlight assembly 70 that are not shown.

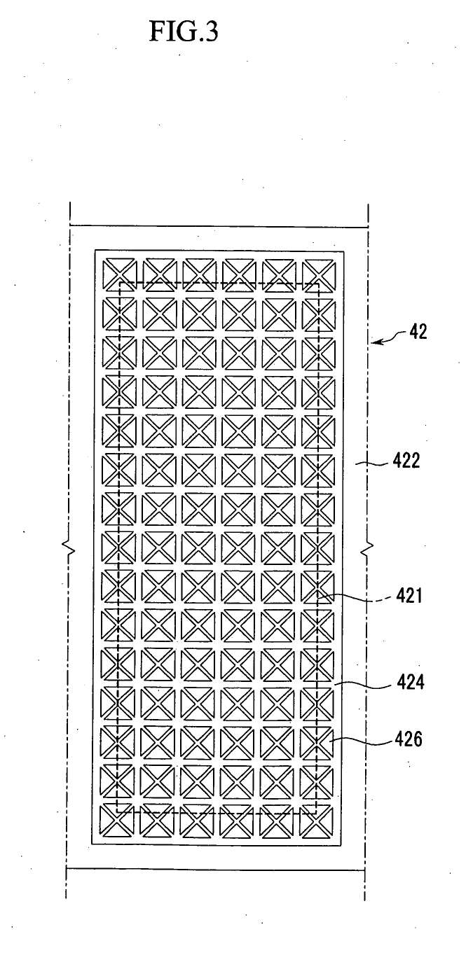

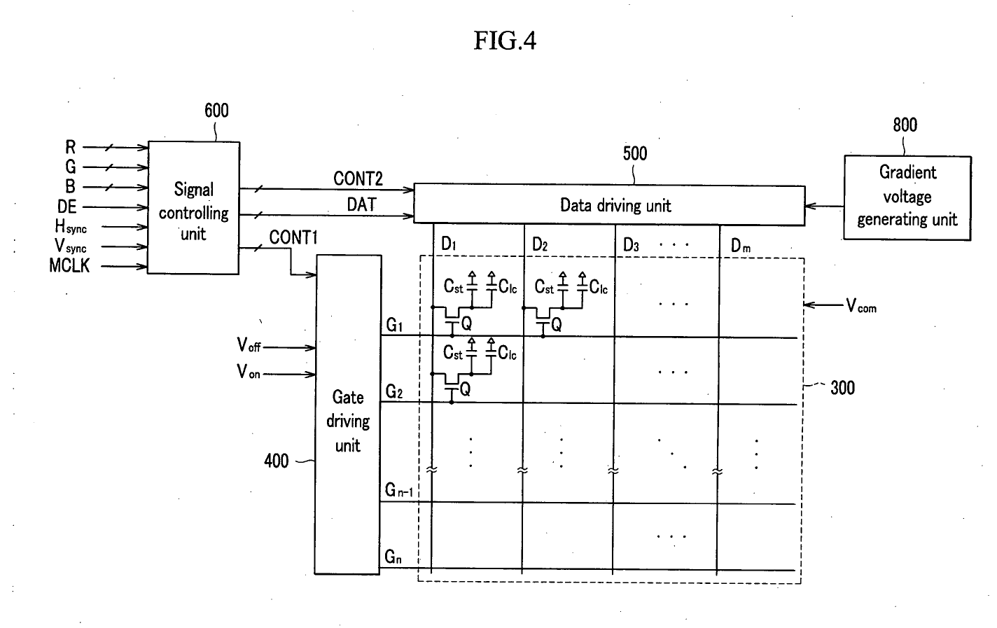

Although FIG. 1 shows a lamp as the light source unit 76, this is not a limitation of the present invention. Thus, the lamp may be replaced by an LED (Light Emitting Diode), and a light source such as a linear light source or a planar light source may be also used. Further, although not shown in FIG. 3, an inverter circuit board and a control circuit board are installed on the rear side of the rear supporting member 75. The inverter circuit board drives the light source unit 76 by converting the power received from a power source into a voltage level and then applying it through a wire and socket connected to the light source unit 76. The control circuit board is electrically connected to the PCB 44, and includes a signal controlling unit 600 (shown in FIG. 4) for the signals for displaying images on the panel unit 50.

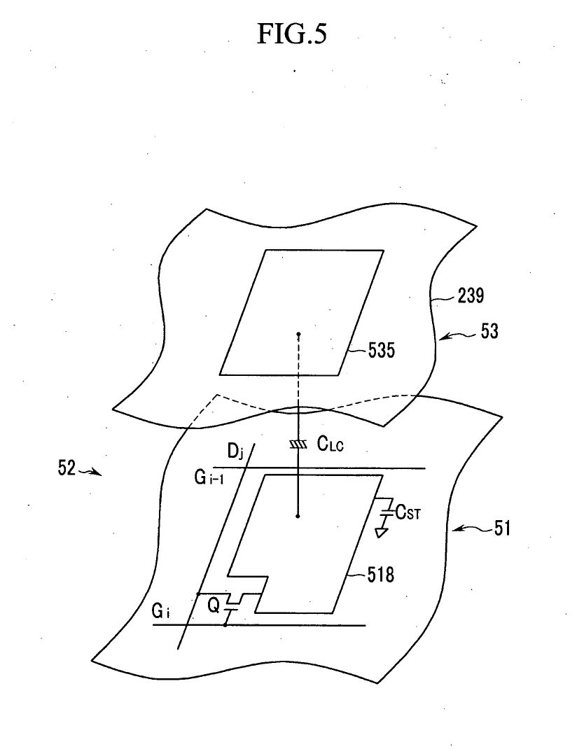

The panel unit 50 includes a first panel 51 and a second panel 53. The second panel 53 is positioned substantially parallel to the first panel 51 and a liquid crystal layer 52 (shown in FIG. 5) is disposed therebetween. In the embodiment shown, the first panel 51 is a rear panel, the second panel 53 is a front panel, and the driver IC packages 41 and 42 are connected to the first panel 51. The gate driver IC package 41 is attached to an edge of a side of the first panel 51, and the gate driver IC package 41 includes an IC chip 411 including a gate driving unit 400 (shown in FIG. 4). The data driver IC package 42 is attached to an edge of the other side of the first panel 51, and the data driver IC package 42 includes an IC chip 421 including a data driving unit 500 (shown in FIG. 4).

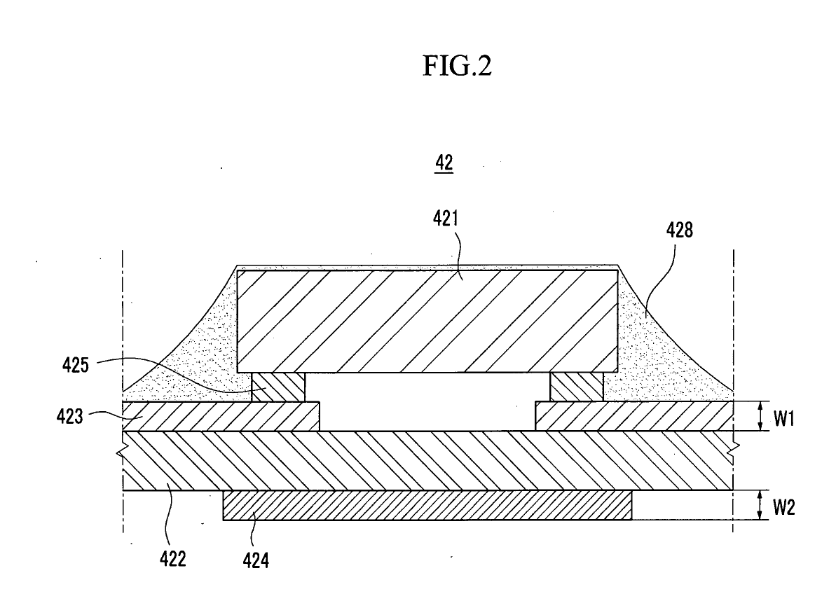

The IC chips 411 and 421 are electrically connected to gate lines and data lines formed in the panel unit 50 through signal patterns 423 (shown in FIG. 2) formed on the base film 422 (shown in FIG. 2), respectively. FIG. 2 shows a base film 422 and signal patterns 423 included in the data driver IC package 42. Although not explicitly shown, the gate driver IC package 41 has a structure that is substantially the same as the data driver IC package 42.

The PCB 44 is connected to the data driver IC package 42, and a plurality of signal lines (not shown), electronic elements, and so on are on the PCB 44. In the embodiment according to the present invention, the gate driver IC package 41 is connected to the PCB 44 indirectly through the panel unit 50. However, this is not a limitation of the present invention and the display device 100 may include PCBs directly connected to the gate driver IC package 41 in some embodiments.

The driver IC packages 41 and 42 according to the first embodiment of the present invention will be described in detail with reference to FIG. 2. FIG. 2 shows a chip-on-film package as the driver IC packages 41 and 42, but this is not a limitation of the present invention and other package types are possible. Now, the data driver IC package 42 will be explained.

As shown in FIG. 2, the data driver IC package 42 includes the base film 422, signal pattern 423 formed on the front side of the base film 422, an IC chip 421, and a heat radiation pattern 424 formed on the rear side of the base film 422. The IC chip 421 is mounted on the base film 422 using a bonding structure 425 and connected to the signal pattern 423. The bonding structure may include an IC bump which is connected to the signal pattern by soldering or anisotropic conductive film. In addition to the above parts, the data driver IC package 42 further includes a protective resin 428 for maintaining a secure connection between the IC chip 421 and the signal pattern 423 and protecting impurities from invading.

The base film 422 is made of a resin such as polyimide, polyester, and so on.

The signal pattern 423 and the heat radiation pattern 424 are made of the same thermally conductive material such as a metal (e.g., Cu). The higher the thermal conductivity of the material, the more efficient heat dissipation will be. The signal pattern 423 and the heat radiation pattern 424 are formed by depositing the conductive material on the base film 422 using a sputtering method.

The signal pattern 423 electrically connects the IC chip 421 mounted on the base film 422 to other electronic elements. The signal pattern 423 may also connect different electronic elements to each other. The driver IC package 42 can electrically connect the panel unit 50 of the display device 100 to the PCB 44.

The heat radiation pattern 424 is formed on the rear side of the base film 422, which corresponds to an area on which the IC chip 421 is mounted. Thus, the heat radiation pattern 424 and the IC chip 421 sandwich the base film 422. In this case, the thickness W2 of the heat radiation pattern 424 is formed to be not more than the thickness W1 of the signal pattern 423. Specifically, the thickness of the heat radiation pattern 424 is in the range of about 5 to 20 μm. If the thickness W2 of the heat radiation pattern 424 is less than 5 μm, heat dissipation efficiency is low. On the other hand, if the thickness W2 of the heat radiation pattern 424 is greater than 20 μm, manufacturing cost increases because the driver IC package 42 is less flexible.

The heat radiation pattern 424 is formed on the rear side of the base film 422, such that heat generated from the IC chip 421 can be dissipated to the outside. Although there is not much barrier to heat dissipation in the upward direction of the IC chip 421, the base film 422 prevents effective heat dissipation in the downward direction of the IC chip 421 without the heat radiation pattern 424. The heat radiation pattern 424 allows effective heat dissipation in the downward direction of the IC chip 421. “Upward” and “downward” are herein used in reference to FIG. 2.

FIG. 3 shows an exemplary heat radiation pattern 424. As shown in FIG. 3, the heat radiation pattern 424 may be laid out in a lattice formation including a checkered pattern and a comb tooth pattern.

As described above, the heat radiation pattern 424 is formed to be relatively thin and to have a lattice formation. Thus, the heat radiation pattern 424 does not cover the entire rear surface of the base film 422 on the other side of the area on which the IC chip 421 is mounted, and a portion 426 of the base film 422 remains exposed. The portion 426 of the base film 422 prevents the driver IC package 42 from decreasing the flexibility of the IC package 42.

If the heat radiation pattern 424 is formed as a thick layer and/or a layer covering the entire rear side of the base film 422 on the other side of the area on which the IC chip 421 is mounted, a heat radiation effect by the heat radiation pattern 424 can be expected. However, in this case, the flexibility of the driver IC package 42 will be too compromised that it will be difficult to use.

Although the heat radiation pattern 424 is shown as a lattice pattern including a checkered pattern and the comb tooth pattern, this is only to illustrate the present invention and the present invention is not limited thereto. The heat radiation pattern 424 may be formed in other patterns as long as the pattern covers less than the entire surface of the base film 422.

The panel unit 50 and the structure for driving the same will be explained in detail with reference to FIGS. 4 and 5.

As shown in FIGS. 4 and 5, a first panel 51 includes a plurality of signal lines G₁-Gₙ and D₁-Dₘ. The first panel 51 and the second panel 53 are connected to the signal lines G₁-Gₙ and D₁-Dₘ and include a plurality of pixels arranged in a matrix formation.

The signal lines G₁-Gₙ and D₁-Dₘ include a plurality of gate lines G₁-Gₙ for delivering gate signals (also called “scanning signals”) and a plurality of data lines D₁-Dₘ for delivering data signals. The gate lines G₁-Gₙ are approximately extended in a first direction and are substantially parallel to each other. Similarly, the data lines D₁-Dₘ are approximately extended in a second direction and are substantially parallel to each other. The first direction and the second direction are substantially perpendicular to each other.

Each pixel includes a switching element Q connected to the signal lines G₁-Gₙ and D₁-Dₘ, a liquid crystal capacitor C_{LC} connected to the switching element Q, and a storage capacitor C_{ST}. In some embodiments, the storage capacitor C_{ST} is omitted.

The switching element Q may be a thin film transistor, and is formed on the first panel 51. The thin film transistor is a device having three terminals, i.e., a control terminal that is connected to the gate lines G₁-Gₙ, an input terminal that is connected to the data lines D₁-Dₘ, and an output terminal that is connected to the liquid crystal capacitor C_{LC} and the storage capacitor C_{ST}.

A gate driving unit 400 applies gate signals that are composed of a gate ON voltage Vₒₙ and a gate OFF voltage V_{off} to the gate lines G₁-Gₙ, and a data driving unit 500 applies data voltage to the data lines D₁-Dₘ.

A gradient voltage generating unit 800 generates two sets of gradient voltages related to transmissivity of the pixel and delivers them to the data driving part 500 as data voltage. One set has a positive value with respect to the common voltage V_{com} and the other set has a negative value.

As shown in FIG. 5, the liquid crystal capacitor C_{LC} has two electrodes, that is, a pixel electrode 518 of the first panel 51 and a common electrode 239 of the second panel 53, and a liquid layer 52 interposed between two electrodes 518 and 239 functions as a dielectric layer. The pixel electrode 518 is connected to the switching element Q. The common electrode 239, which is formed on substantially the entire surface of the second panel 53, receives the common voltage V_{com}. Different from FIG. 4, the common electrode 239 may be formed on the first panel 51, and at this point, either one of two electrodes 518 and 239 may be formed in the shape of a line or bar. Further, a color filter 535 is formed on the second panel 53 to color the transmitted light. In some embodiments, the color filter 535 may be formed on the first panel 51.

The storage capacitor C_{ST} that is auxiliary to the liquid crystal capacitor C_{LC} is composed of a separate signal line (not shown) provided in the first panel 51 and a pixel electrode 518 using an insulation layer as a medium. A fixed voltage such as the common voltage V_{com} is applied to the separate signal line. In some embodiments, the storage capacitor C_{ST} may be composed of the pixel electrode 518 and the gate lines G₁-Gₙ using an insulation layer as a medium.

A polarizer (not shown) for polarizing light is attached to the outside of at least one of two substrates 51 and 53 of the panel unit 50.

With such a structure, if a switching element (that is, a thin film transistor) is turned ON, an electric field is formed between the pixel electrode 518 and the common electrode 239. The electric field changes the orientation of the liquid crystals in the liquid crystal layer 53 formed between the first panel 51 and the second panel 53. Desired images are displayed by controlling the orientation of the liquid crystals to change light transmission level.

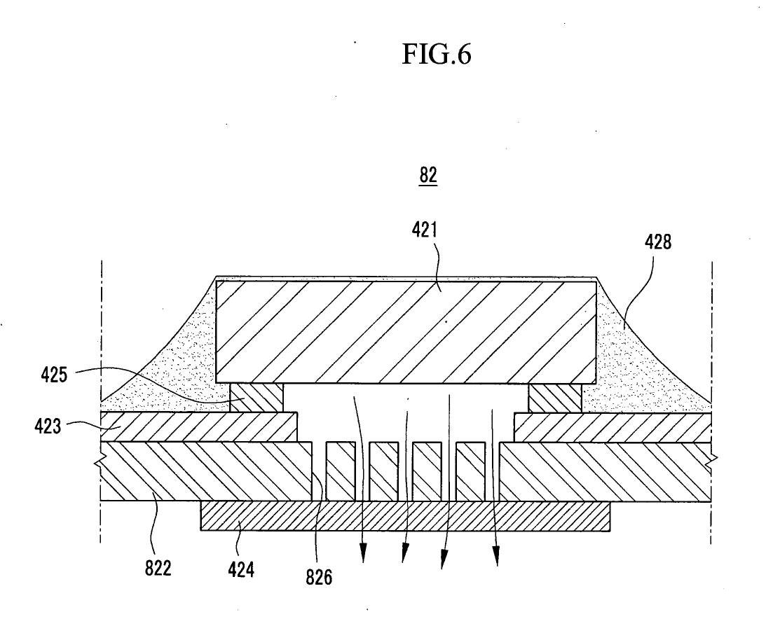

A second embodiment according to the present invention will be explained with reference to FIG. 6. FIG. 6 is a cross-sectional view of a driver IC package 82.

In the driver IC package 82 provided in a display device 100 according to the second embodiment of the present invention, a plurality of heat escape holes 826 are formed on an area of a base film 822 on which the IC chip 421 is mounted. The number and size of such heat escape holes is proportional to heat dissipation efficiency. Therefore, as long as structural problems do not occur in the driver IC package 82, it is preferable to form as many heat escape holes 826 as possible.

If a plurality of heat escape holes 826 are formed on the base film 822, the heat generated from the IC chip 421 flows to the heat radiation pattern 424 through the heat escape holes 826 (as shown by the arrows). The heat is transferred out of the driver IC package 82 through the heat radiation pattern 424, which helps dissipate the heat.

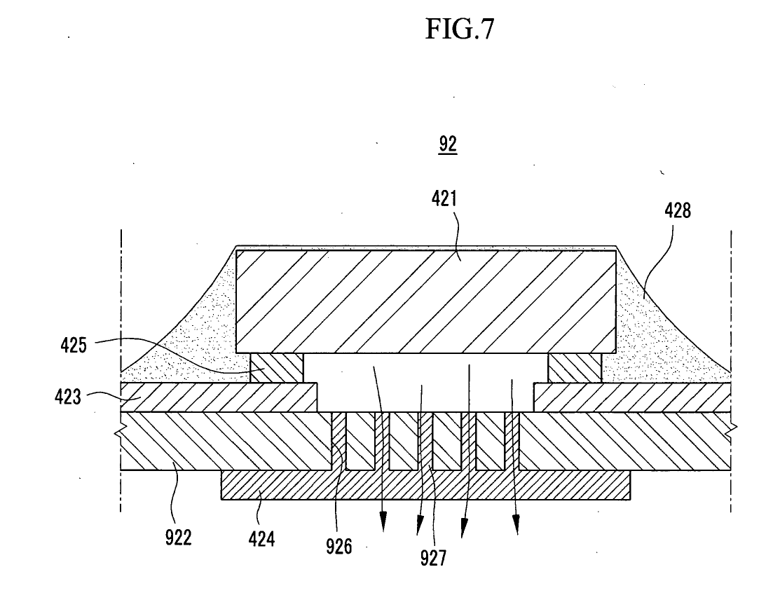

A third embodiment according to the present invention will be explained with reference to FIG. 7. FIG. 7 is a cross-sectional view of a driver IC package 92.

The driver IC package 92 provided in a display device according to the third embodiment of the present invention includes a plurality of heat escape holes 926 formed on an area of a base film 922 on which the IC chip 421 is mounted and a heat transferring portion 927 formed in the heat escape holes 926. In addition, the heat transferring portion 927 is connected to the heat radiation pattern 424. Here, the heat transferring portion 927 is made of the same material as the heat radiation pattern 424. For example, the heat transferring portion 927 may be made of a thermally conductive metal such as Cu.

As described above, the heat transferring portion 927 is formed to fit through the heat escape holes 926 and is connected to the heat radiation pattern 424. The heat generated by the IC chip 421 can be effectively dissipated to the outside as indicated by the arrows.

As described above, it is possible to improve heat dissipation efficiency by using the driver IC package.

Furthermore, the driver IC package includes a heat radiation pattern that is formed by the same material and the same method as the signal pattern, and the heat radiation pattern helps dissipate the heat generated from an IC chip. The overall effect of the heat radiation pattern is that the heat dissipation is done more efficiently.

The heat radiation pattern is laid out in a lattice formation so that sufficient heat efficiency can be obtained without compromising the flexibility of the driver IC package.

Since heat escape holes are formed on the base film included in the driver IC package, it is possible to effectively emit heat generated from the IC chip.

A heat transferring portion is formed on the heat escape holes to further improve heat dissipation.

Although the exemplary embodiments of the present invention have been described, the present invention is not limited to the embodiments, but may be modified in various forms without departing from the scope of the appended claims, the detailed description, and the accompanying drawings of the present invention. Therefore, it is natural that such modifications belong to the scope of the present invention.

What is claimed is:

1. A driver IC package comprising:
a base film;
a signal pattern formed on a first side of the base film;
an IC chip mounted on the base film via a bonding structure, the IC chip being connected to the signal pattern; and
a heat radiation pattern formed on a second side of the base film, the heat radiation pattern positioned such that the base film is between the IC chip and the heat radiation pattern.

2. The driver IC package of claim 1, wherein a plurality of heat escape holes are formed through the base film between the IC chip and the heat radiation pattern.

3. The driver IC package of claim 2 further comprising heat transferring portions physically coupled to the heat radiation pattern, wherein heat transferring portions extend through the heat escape holes.

4. The driver IC package of claim 3, wherein the heat transferring portions are made of the same material as that of the heat radiation pattern.

5. The driver IC package of claim 1, wherein the signal pattern and the heat radiation pattern are formed by depositing metallic materials on the base film using a sputtering method.

6. The driver IC package of claim 1, wherein the signal pattern and the heat radiation pattern are made of the same metallic material.

7. The driver IC package of claim 6, wherein the metallic material is copper.

8. The driver IC package of claim 1, wherein the heat radiation pattern includes a lattice formation.

9. The driver IC package of claim 1, wherein the thickness of the heat radiation pattern is equal to or less than the thickness of the signal pattern.

10. The driver IC package of claim 9, wherein the thickness of the heat radiation pattern is in the range of about 5 μm to about 20 μm.

11. A display device comprising:
a panel unit for displaying images;
a printed circuit board (PCB) for transmitting driving signals to the panel unit; and
a driver IC package for electrically connecting the PCB to the panel unit,
wherein the driver IC package comprises:
a base film,
a signal pattern formed on a first side of the base film,
an IC chip mounted on the base film via a bonding structure and connected to the signal pattern, and
a heat radiation pattern formed on a second side of the base film such that the base film is between the IC chip and the heat radiation pattern.

12. The display device of claim 11, wherein a plurality of heat escape holes are formed through the base film between the IC chip and the heat radiation pattern.

13. The display device of claim 12 further comprising heat transferring portions physically coupled to the heat radiation pattern, wherein the heat transferring portions extend through the heat escape holes.

14. The display device of claim 13, wherein the heat transferring portions are made of the same material as that of the heat radiation pattern.

15. The display device of claim 11, wherein the signal pattern and the heat radiation pattern are formed by depositing a metallic material on the base film using a sputtering method.

16. The display device of claim 11, wherein the signal pattern and the heat radiation pattern are made of the same metallic material.

17. The display device of claim 16, wherein the metallic material is copper.

18. The display device of claim 11, wherein the heat radiation pattern includes a lattice formation.

19. The display device of claim 11, wherein the thickness of the heat radiation pattern is equal to or less than the thickness of the signal pattern.

20. The display device of claim 19, wherein the thickness of the heat radiation pattern is in the range of about 5 μm to about 20 μm.

21. The display device of claim 11 further comprising a backlight assembly for providing light to the second side of the panel unit.

22. The display device of claim 11, wherein the panel unit is a liquid crystal panel unit.
